(19) United States
(12) Patent Application Publication
(10) Pub. No.: US 2023/0022401 A1
(43) Pub. Date: Jan. 26, 2023

(54) Multi-Level Time Series Forecaster

(71) Applicant: Ciena Corporation, Hanover, MD (US)

(72) Inventors: Maryam Amiri, Ottawa (CA); Petar Djukic, Ottawa (CA); Todd Morris, Stittsville (CA)

(21) Appl. No.: 17/382,723

(22) Filed: Jul. 22, 2021

(51) Int. Cl. G06N 5/04; G06N 20/00; H04L 12/26

(52) U.S. Cl. CPC G06N 5/04; G06N 20/00; H04L 43/08

(57) ABSTRACT

Systems and methods for forecasting time series data are provided. In one implementation, a method includes the steps of obtaining time series data from a network. The method also comprises the step of determining one or more forecasters to be used based on a type of the time series data and based on previous training that determine that the one or more forecasters from a number of forecasters are best suited for the type of time series data. The method further comprises making a forecast of the time series data using the one or more forecasters and to save and/or display the forecast.

### FIELD OF THE DISCLOSURE

The present disclosure generally relates to forecasting. More particularly, the present disclosure relates to systems and methods for performing forecasting of time series data, such as network time series data.

### BACKGROUND OF THE DISCLOSURE

Historical data is commonly observed to predict future data. That is, a pattern may be detected in a time series data to forecast data that is expected to but yet to be observed. Training based on a large number of historical data can contribute to an accurate predictor of future data but when historical data is limited in size, prediction is not as accurate because there is not enough data samples to warrant effective training of a model to achieve precise prediction. In summary, short time series data creates problems when trying to train as there is not enough samples for training.

A higher capacity model, a model that is based on a large sample size, that is based on deep neural networks, can learn a prediction model through representation learning but only if enough data is available. Low-capacity models typically have a built-in model of the time series, accordingly, not every low-capacity model is suitable for every time series. That is, the implicit or explicit internal or built-in model may not match the actual random process of the time series. There is essentially, a model and time series data mismatch. It is therefore necessary to match a low-capacity model to the behavior or type of a time series data. Such a matching process is conventionally a manual process performed by forecasting experts, and lacks practicability. The current forecasting approaches for short time series are to use manual handcrafting of features and manual selection of the forecaster.

Therefore, there is a need for an automated and fast way of selecting forecasters that are well suited for various time series data types.

### BRIEF SUMMARY OF THE DISCLOSURE

The present disclosure explores new problem areas for forecasting. The typical use cases in networking include forecasting packet counts, bit error rates, and signal-to-noise ratios, etc. The forecasting approaches of the present disclosure may be similarly applied to non-networking applications, such as, business management, Internet of Things (IoT), anomaly detection, etc. Conventionally, these use cases are addressed with regression techniques. Regression techniques are the classical “forecasting” algorithms. Forecasting algorithms require a high touch approach where an expert in the use of these algorithms is able to choose the approach best suited for the forecasting, based on their observations about the time series. Another problem with the regression approaches is their low capacity. Capacity is informally defined as the ability of the algorithm to fit a wide variety of functions. For example, linear regression has a low capacity as it cannot fit a highly varying time series. Also, a higher order polynomial regression will typically overfit the time series due to its low ability to generalize.

According to one implementation of the present disclosure, a method for forecasting is provided. The method includes obtaining time series data from a network. One or more forecasters are then determined to be used based on a type of the time series data and based on previous training that determine that the one or more forecasters from a number of forecasters are best suited for the type of time series data. The method further includes making a forecast of the time series data using the one or more forecasters to save and/or display the forecast.

According to another implementation, a non-transitory computer-readable medium configured to store a program executable by a processing system is provided. The program includes instructions to cause the processing system to obtain time series data from a network. The program also causes the processing system to determine one or more forecasters to be used based on a type of the time series data and based on previous training that determine that the one or more forecasters from a number of forecasters are best suited for the type of time series data. Also, the program causes the processing system to make a forecast of the time series data using the one or more forecasters and to save and/or display the forecast.

According to yet another implementation, a method comprises the step of obtaining time series data from a network. The method also comprises the step of determining one or more forecasters to be used based on a type of the time series data and based on previous training that determine that the one or more forecasters from a number of forecasters are best suited for the type of time series data. The method further comprises making a forecast of the time series data using the one or more forecasters and to save and/or display the forecast.

According to another implementation, a system including a processor and software stored in memory that when executed causes the system to forecast time series data is discloses. The system obtains time series data from a network. Further, the system determines one or more forecasters to be used based on a type of the time series data and based on previous training that determine that the one or more forecasters from a number of forecasters are best suited for the type of time series data. Additionally, the system makes a forecast of the time series data using the one or more forecasters and saves and/or displays the forecast.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of a training phase of a forecasting system;

FIG. 2 is a diagram of a classification phase of a forecasting system;

FIG. 3 is a diagram of a prediction phase of a forecasting system; and

FIG. 4 is a flow chart of a method for forecasting time series data, in accordance with an embodiment of the disclosure.

FIG. 5 is a block diagram of a processing system.

### DETAILED DESCRIPTION OF THE DISCLOSURE

In various embodiments, the present disclosure relates to systems and methods for forecasting, and more particularly relates to forecasting of time series data. Conventional systems may be used to detect patterns, but typically do not detect patterns in data obtained specifically from a time series. Forecasting in a time series, according to the present disclosure, may be used in the field of Machine Learning (ML) for networking applications, telecommunications, as well as many other applications. For example, in the field of networking applications, forecasting can be used in the following use cases: packet count, packet loss, bit error rate (BER), and signal-to-noise ratio (SNR), among others. Forecasting can also be used in other areas (e.g., Internet of Things (IoT) devices, business environments, etc.).

Time series data can also be one-dimensional or multi-dimensional. For example, multiple sensors can provide data at about the same time, whereby this sensor data can be stacked together to provide a time series that has multiple types of measurements associated with each time point. For example, packet counts, link utilizations, flow data records and memory utilization can all be collected from the same routing/switching elements. The patterns described here are detected across this potentially multi-dimensional time series.

A method for forecasting future points of time series when historical data in the time series is limited is disclosed. In some cases, the time series data has few samples making it nearly impossible to create a generalized, high-prediction capacity forecaster. Instead, the forecasting problem requires a more specialized forecaster, such as those described herein. In accordance with a two-step process, the time series data is classified and then based on the classification, a specialized forecaster best suited for the corresponding time series data is deployed. The classification of the time series data is based on the properties (type) of the time series and the historical (previous) samples of the time series data, both of which become known during training of the time series data. During the prediction phase the most recent historical data is used for the classification and prediction.

In some embodiments of the disclosure, the search for the best suited forecaster is continuous where the system redetermines a forecaster, among a set of forecasters, to maintain forecasting accuracy. In some embodiments of the disclosure, the output of the forecaster selected as the best suited forecaster is monitored for performance and when or if performance deteriorates, the time series data undergoes further training to accommodate anomalies or a sudden change in the time series data. For example, data collected at a certain time in the day might be changed to the collection of data at a different time in the day when properties of the time series data also change. In this example, a current forecaster is unlikely to forecast as accurately as prior to the change in the temporal collection of data but with continual re-determination of forecaster and/or re-training, forecasting is likely improved.

The forecaster of various embodiments of the disclosure offer, in some cases, over 40% improvement over conventional forecasters because the best forecaster for the time series is selected based on the output of a time series classifier. That is, the time series data, despite lacking enough data points to train a high-capacity forecaster, has an adequate number of data points to train a classifier for the corresponding time series. Accordingly, the limited data in the time series is used to train a classifier while using a simpler forecaster that may overfit over multiple time series but that would not overfit each individual time series. Noteworthy, the historical data required for forecasting is readily available, without delay and in real time, given prior training sessions.

The performance of the disclosed forecasters relative to certain machine learning algorithms, specifically, Naïve, random forest, and ensemble cascade, is now summarized. In the Naïve training model, the forecast corresponds to the last observed value. This kind of forecast assumes that the stochastic model generating the time series data is a random walk. The proposed forecaster provides better accuracy than the Naïve algorithm by approximately 41%, indicating that the former is learning from the data. The Random Forest algorithm is an ensemble learning approach which makes use of randomized decision trees. It is easier to implement the Naïve algorithm and has shown reasonable performance in many applications. The disclosed forecaster improves accuracy over the Random Forest approach by approximately 37% in accuracy and accuracy over a cascade approach is approximately 33% better with some of the disclosed methods herein. Further, the prediction time of current approaches over those implementing the Random Forest algorithm is observed to be over seven times better. Among a family of Ensemble algorithm methods using different algorithms, there is a cascading method which is made of an ordered chain of predictors using different predicting algorithms. In the prediction phase, the first predictor in a chain is used, subsequently, the result is fed into a simple classifier to determine a level of confidence of the predictor. In response to an acceptable level of confidence, the result is provided as prediction result, and in response to an unacceptable level of confidence, the next predictor in the chain is implemented. This process is repeated until a confident predictor is found. The current forecaster is almost an order of magnitude faster than the Ensemble algorithms; accordingly, it is 100 times faster than ensemble algorithms in training, and prediction phase.

The forecasters of various embodiments demonstrate especially improved performance with small sets of very short time series data that have different characteristics in terms of sparsity and fluctuation. In some case, current approaches exhibit at least a 10% improvement in forecasting over conventional forecasters intended for similar limited data time series.

Various applications of the disclosed forecasting approach include but are limited to network and telecommunications, IoT, and supply chain forecasting. In forecasting of IoT devices, the hard disk space may be limited and only a low number of historical points may be available for prediction. Forecasting in a Network Management Software (NMS) system where data is saved for a short amount of time (e.g., 14 days) may also face a deficit of time series data. Forecasting in business environments may also face limited data where only monthly or quarterly data is available. In all three scenarios, approaches of various embodiments offer accurate forecasting despite limited data availability.

In current approaches, with limited sized historical data, a low-capacity method with a built-in time series model is employed as there is not enough data to train a higher capacity model. A higher capacity model, based on deep neural networks, can learn the model itself through representation learning but only if enough data is available. Low-capacity models typically have a built-in model of the time series, accordingly, not every low-capacity model is suitable for every time series because the implicit or explicit internal model may not match the actual random process of the time series data. In accordance with various embodiments, a low-capacity model is matched to the behavior or type of time series data. Conventionally, this process may be manual, performed by forecasting experts. A manual procedure is impractical in many situations. Various approaches of the disclosure offer an automated way to select a low-capacity model.

In some embodiments of the disclosure, a two-step forecaster is implemented. The forecaster leverages multiple low-capacity models to make time series forecasts and an automatic mechanism to select a forecaster that can make the best suited forecasts. The set of models used for prediction is not fixed and can incorporate any types of time series forecasters, such as those with different levels of complexity including Naïve, statistical models, Random Forest or other decision trees, regression neural network (RNN) models, etc. The proposed approach includes two machine learning parts: a number of time series (TS) forecasters and one TS classifier. At prediction time, the TS classifier first classifies the time series data based on the type of time series data and associates the time series data with one of the TS forecasters. Subsequently, the selected TS forecaster facilitates prediction of the forecast of the time series data. The proposed approach can be used for both single variate timeseries and multi-variates timeseries at the same time without imposing limitations.

An alternative way to select a forecaster, in accordance with some embodiments of the disclosure, is, at inference time, a brute force search is performed where the best suited forecaster for every available model is trained and then tested by forecasting historical time series data. The best performing model is then selected for forecasting. This particular approach may not be practical for prediction in a short amount of time (e.g., business environments) or if there are too many different time series data to forecast because a large amount of compute resources is required to make the forecast. For practicality, the TS classifier of some embodiments may instead select a subset of the forecasters as well as a single forecaster. If a subset of forecasters is chosen, then a brute force search may be performed on the subset to find the best forecaster.

In yet another alternative approach for selecting a forecaster, a fixed assignment of time series data to a forecaster may be stored in a table or a database. However, association of never before seen time series data with existing forecasters may yield poor prediction outcomes with this approach. Additionally, the TS classifier approach discussed above saves on the training costs relative to the fixed assignment of the time series data to forecaster approach.

In the interest of clarity of illustration, in the remainder of the disclosure, a system for automatically training a fixed number of forecasters on a fixed number of time series is discussed. It is noted however that the various embodiments of the disclosure are not limited to this approach and the systems and methods described herein also work on a variable number of forecasters and on a variable number of time series data. Further, the described system can be adapted to continuously learn which forecaster is the best fit for each time series data.

### Time Series Data Forecasting With Multiple Forecasters

A collection of single variate time series data and/or multi-variate time series data are denoted by xₖ where k ∈{1,..., K}. In a typical scenario of TS forecasting, the historical window size (W) of each time series is provided and the forecaster predicts future samples of the time series referred to herein as “horizon” with size (h). A window is a period of time during which time series data is observed or collected.

At the time of forecast, previous values of each time series data are available, starting at time t₀, represented by Equation (1) below:

$${\text{X}}_{\text{k}} \left({\text{t}}_{0} , {\text{t}}_{0} + Δ , ... , {\text{t}}_{0} + \left(\text{w-1}\right) Δ\right) ,$$

where “Δ” represents an incremental time change, The forecaster of an embodiment of the disclosure generates an estimate of the time series data and “h” represents the number of future values of the time series, which are not known, as follows:

$$\text{X} \hat{\text{k}} {\text{(t}}_{0} + \text{w} Δ , {\text{t}}_{0} + \left(\text{w+1}\right) Δ , ... , {\text{t}}_{0} + ( \text{w+h)} Δ \text{)}$$

As time evolves, an additional number of time series data values become available, as represented by Equation (3) below:

$${\text{X}}_{\text{k}} \left({\text{t}}_{0} + \text{w} Δ \text{,} {\text{t}}_{0} + \left(\text{w+1}\right) Δ , ... , {\text{t}}_{0} + \left(\text{w+h}\right) Δ\right) ,$$

Equation (3) can be used to check the validity (error) of the estimate x _{k̂} (t₀+_{WΔ}, t₀+(w+1)Δ,... ,t₀+(w+h)Δ) and evaluate the performance of the forecaster.

Assuming there are L different forecasters available to provide such estimates for each individual timeseries, the generated estimates are denoted by

$$\text{X} \hat{\text{k}} \text{l}$$

(t₀+wΔ, t₀+(w+1)Δ,... ,t₀+(w+h)Δ) where I∈{1, ... ,L}. There are different model selection criteria that can be used to measure how well different models predict the future values, such as Root Mean Square Error (RMSE), Mean Absolute Percent Error (MAPE), Akaike Information Criteria (AIC), and etc. Based on various scoring techniques, a score for the forecast coming from each of the forecasters can be determined: Sₖₗ is the score from the forecast generated by I^{th} forecaster for k^{th} time series.

Three different operating phases are defined for the proposed predictor: (1) forecaster training, (2) TS classifier training and (3) prediction phase. Before the first two phases the dataset is divided into two partitions. The first data partition is used for forecaster training, while the second partition is used for TS classifier training.

### Forecaster Training

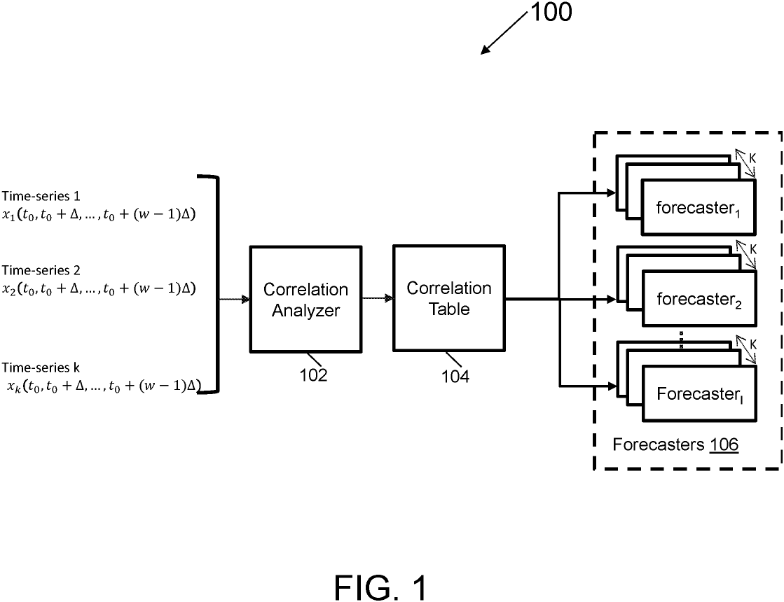

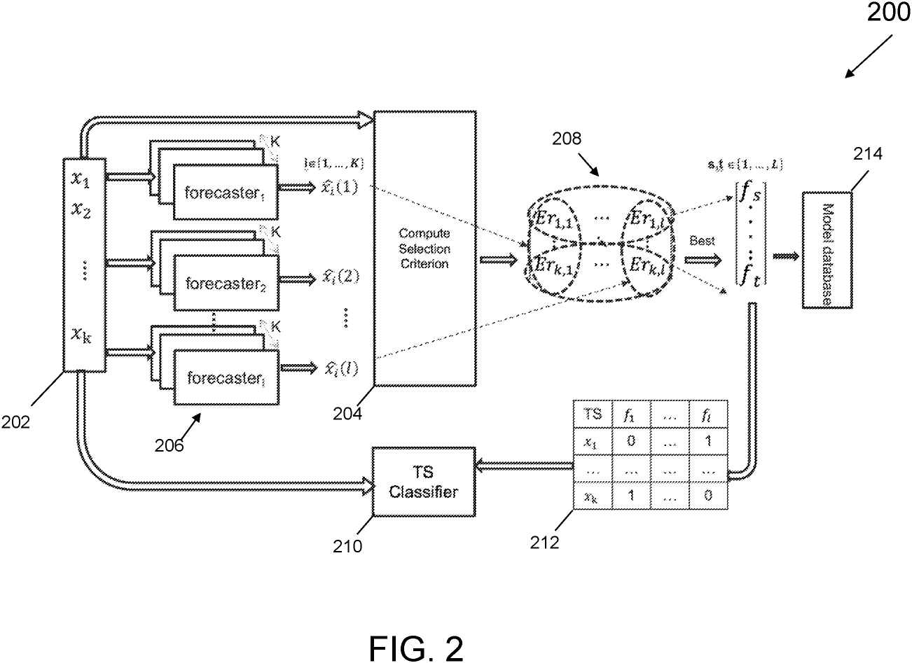

In scenarios where there are many time series and training may be computationally costly, a faster approach is employed to reduce the computational time required to train the time series data. FIG. 2 shows a diagram of a training forecaster system 100, in accordance with an embodiment of the disclosure. System 100 includes a correlation analyzer 102, correlation table 104, and forecasters 106. The correlation analyzer performs a cross-correlation analysis on the time series data to find the most similar time series in terms of patterns that exist in the time-series. For example, some times-series may contain seasonalities (repeating patterns), while other may include growth patterns. The correlation analysis finds those patterns when they occur on a similar time-scale. The system 100 may be a physical computing device that may implement the functions of a training forecaster in circuitry. The system 100 may be a virtual computing device that may implement the functions of a training forecaster in software stored in a memory and executed by a processor. Alternatively, the system 100 may be a combination of physical and virtual machines. Correlation analyzer 102 may be a physical computing device or a virtual computing device, such as, without limitation, a processor and supporting circuitry (e.g., input/out devices, memory) or software, respectively. In FIG. 1, forecasters 106 is shown to include “L” number of groups of forecasters with each group including “K” number of forecasters.

The associations of correlated time series data are maintained in a correlation table 104 in local or external memory. In this manner, groups of similar time series data are created at the table 104. The training forecaster system 100 selects an individual time series data from each group, k, of time series data as a representative of the corresponding group of time series data and employs the selected time series data for input to the training forecasters 106. In accordance with an exemplary method of implementing predictor 100 is to employ machine learning algorithms to implement correlation table 104 to use unsupervised clustering of similar time series data and assigning the centroid of each cluster (group) as a representative time series data to train a forecaster.

### TS Classifier Training

The second partition of the time series data is used to train the TS classifier. In this phase, the forecasters are in an inference mode (making predictions, not training). The forecasters are used to create a K×L matrix, where each element of the matrix k,l corresponds to the performance of forecaster I on time series k. A metric is chosen to evaluate the performance of the forecaster on the available historical data. A qualifying metric (e.g., symmetrical Mean Absolute Percentage Error (MAPE) - sMAP). measures the quality of the forecasts. The metric is calculated with the forecast

$$\text{X} \hat{\text{k}} \text{l}$$

with known historical values Xₖₗ.

FIG. 2 shows a diagram of a TS classifier training system 200, in accordance with an embodiment of the disclosure. In some embodiments, the system 200 is a physical computing system including circuitry for implementing the functions of a TS classifier training. In some embodiments, the system is a virtual system that implements the functions of a TS classifier training in software stored in memory and executing on a processor. Alternatively, the system 200 may be implemented as a combination of physical and virtual machines.

With continued reference to FIG. 2, the historical values xₖₗ are input to the system 200. A KxL matrix of historical values are provided to L forecasters 206. Each of the L forecasters 206 includes K forecasters, as discussed above relative to FIG. 1. A compute selection criterion block 204, in addition to an error block 208, select one or more of the K forecasters best suited for the historical data, as discussed further below. The system 200 further includes a model database 214 and a TS classifier 210, which receives the historical data and the output of a table 212 of associations of historical data types to best fit forecasters, as further discussed below.

A forecaster, among the forecasters 106, with the best value of selection criterion is selected by the system 100. The definition of “best” depends on the selection criterion, for example, “best” can be a maximum or a minimum of a particular criterion. In some cases, the selection criterion of a forecaster is greater than a threshold to be considered as the best forecaster for a corresponding time series data. In some embodiments, by default, one forecaster is used for all-time series data, and if in the selection process, none of forecasters is selected as the best, the default forecaster is assigned. The output of the error block 208 is used to calculate the scoring matrix S where stT ∈{1, ..., L}, by the system 100. The scoring matrix S is used to create the table 212.

Models of selected forecasters along with their corresponding parameters and weights are stored in the model database 214 to be used in the prediction phase. When the best forecasters (denoted by ft in FIG. 2) are determined, time series data and the forecaster are provided to TS classifier 210 for training the TS classifier 210. The best forecaster need not be a different forecaster and may be the same forecaster with different parameters or hyper-parameters e.g., parameters may be the trainable weights of a DNN, or trainable parameters of a linear regression model, while the hyper-parameters may be describing the number of hidden layers, type of activation functions in RNN, history window size for moving average and seasonality model in low-capacity forecaster, and/or weights. For parameters, it is possible that there are multiple forecasters with the same type e.g., fbprophet by with different configurations (Additive or Multiplicative). So, the set of models can include different types of predictors with different configurations. The classifier 210, in FIG. 2, is trained to recognize the patterns in the time series data for identification at a subsequent time. The label associated with the forecaster best for a time series data is one-hot encoded to be used as a label for the classifier. In this manner, during training, the TS classifier learns to map the patterns in the time series data to the corresponding forecasters. The trained classifier can then be used at inference time to associate a time series data with the forecaster best suited for the time series data. In some cases, multiple time series data use the same forecaster. Data for training the TS classifier can be prepared in real time. Further, there is no need to manually prepare the labeled dataset. The classifier may also be a fixed algorithm that is not trained (e.g., a switch statement), or a classifier that was bootstrapped to a given selection prior to training.

Noteworthy, with little change in the structure of the system 200 of FIG. 2, it is possible to use an unsupervised approach to classification such that the time series data are first classified into different categories using the unsupervised approach, such as clustering. Then for each group, a representative is chosen, the best forecaster is found and is later used for all-time series data belonging to the group.

### Prediction Phase

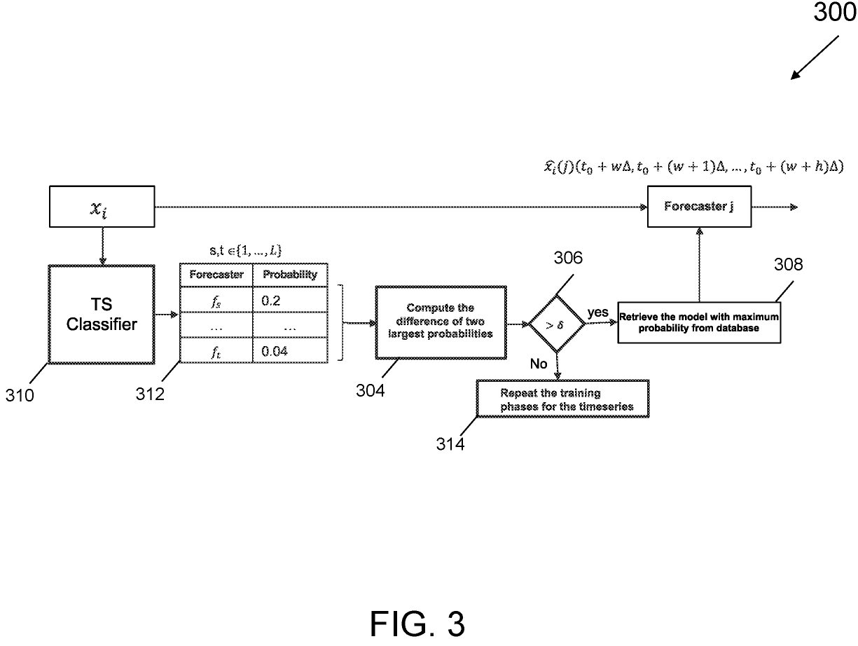

FIG. 3 shows a diagram of a prediction system 300, in accordance with an embodiment of the disclosure. The system 300 is shown to include a TS classifier 310, which is provided with historical data input, xᵢ, where “i” represents samples. Xᵢ is further provided as input to ultimately select a forecaster j. The output of the TS classifier 310 is provided as input to a table 312 with associations of forecasters and statistical information relating to the forecasters. For example, table 312 shows forecasters associated with their corresponding probabilities of prediction. Statistical information in table 312 is not limited to probabilities and can be other or an additional type of statistical information.

The output of table 312 is used, at 304, to compute the difference of the two largest probabilities of the table 312. If, at 306, the two largest two probabilities are determined to exceed a threshold value, δ, training of the time series data is repeated, as shown at 314. For example, the training discussed and shown relative to FIG. 1 is repeated. Otherwise, if the difference between the two largest two probabilities is determined to exceed the threshold value, at 306, the model associated with the maximum probability of forecasters is retrieved (i.e., forecaster j) from a model database, at 308. In some embodiments, the model may be retrieved from the model database 214 of FIG. 2. It is understood that the threshold test at 306, of FIG. 3, is optional where forecaster j may simply be the highest probability forecaster of table 312. When employed, the threshold test guards against an erroneous prediction because normally, the disparity between the greatest probabilities of the forecasts is expected to be large. When the forecaster j is retrieved at 308, the forecaster j is used to forecast future data based on the historical data, xᵢ.

By way of further detail referencing FIG. 3, during the prediction phase, each time series data is provided to the classifier 310, and the classifier 310 provides a probability distribution over a set of forecasters according to the pattern of the time series data. The maximum difference between the two largest probabilities is computed to check against a predefined confidence threshold (δ) to ensure if the selected forecaster with maximum probability is likely satisfactory for use. Subsequently, the most likely forecaster is chosen to be used for prediction, and the corresponding model which has been previously stored in model database is retrieved, and an instance of the forecaster is constructed to predict the future values (horizon).

It is possible that the patterns of time series data may change during the time that the classifier is trained and the time the time series data is used for inference. In this scenario, if the new pattern is among the patterns that the TS classifier was trained on, the forecast prediction would be satisfactory because the corresponding forecaster for the new pattern is available. However, in the case where the pattern is completely new, the TS classifier is expected to produce a uniform distribution across the classifiers as it compares the maximum difference against the threshold. If this occurs, a random forecaster can be selected, or a set of forecasters, instead of one forecaster, can be selected, or the training phase with the new time series data may be repeated.

In an unsupervised approach, a similar structure of prediction, such as shown in FIG. 3 may be employed such that the time series data are first classified into different categories and subsequently prediction is performed.

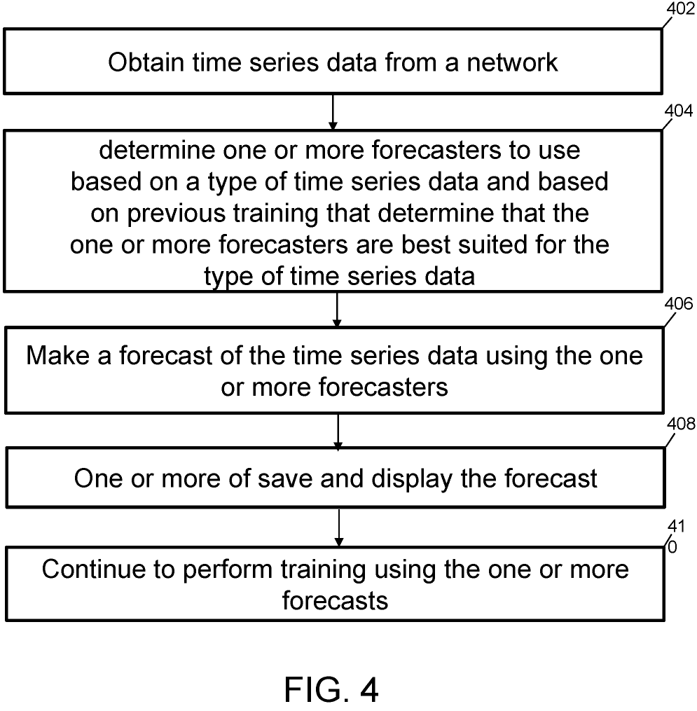

FIG. 4 shows a flow chart of a method for forecasting time series data, in accordance with an embodiment of the disclosure. At step 402, time series data, such as the time series data of FIGS. 1-3, is obtained from a network. The time series data may represent a characteristic of the network, such as packet count, packet loss, SNR, BER, etc. Based on the time series data (i.e., previous training and the time series data types), at step 404, one or more forecasters among a number of forecasters is determined, such as shown and discussed relative to FIG. 2, that are best suited for the type of time series data. At step 404, the selected forecaster need not be a different forecaster than a previously selected forecaster and may instead be the same forecaster but with different parameters. At step 406, a forecaster (e.g., system 300 of FIG. 3) makes a forecast of the time series data using one or more of the forecasters determined at step 404. At step 408, the forecast time series data is saved in memory and/or displayed to a user on a graphical user interface of a computing device. At step 410, forecast training (e.g., by the system 300 of FIG. 3) is continually performed. In some embodiments of the disclosure, the determining of one or more forecasts and making a forecast steps (404 and 406) are repeated.

### Processing System

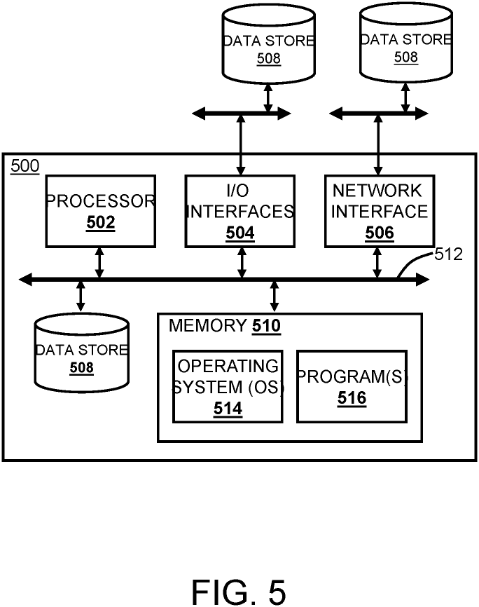

FIG. 5 is a block diagram of a processing system 500. The processing system 500 may be a digital computer that, in terms of hardware architecture, generally includes a processor 502, input/output (I/O) interfaces 504, a network interface 506, a data store 508, and memory 510. It should be appreciated by those of ordinary skill in the art that FIG. 5 depicts the processing system 500 in an oversimplified manner, and a practical embodiment may include additional components and suitably configured processing logic to support known or conventional operating features that are not described in detail herein. The components (502, 504, 506, 508, and 510) are communicatively coupled via a local interface 512. The local interface 512 may be, for example, but not limited to, one or more buses or other wired or wireless connections, as is known in the art. The local interface 512 may have additional elements, which are omitted for simplicity, such as controllers, buffers (caches), drivers, repeaters, and receivers, among many others, to enable communications. Further, the local interface 512 may include address, control, and/or data connections to enable appropriate communications among the aforementioned components.

The processor 502 is a hardware device for executing software instructions. The processor 502 may be any custom made or commercially available processor, a Central Processing Unit (CPU), an auxiliary processor among several processors associated with the processing system 500, a semiconductor-based microprocessor (in the form of a microchip or chipset), or generally any device for executing software instructions. When the processing system 500 is in operation, the processor 502 is configured to execute software stored within the memory 510, to communicate data to and from the memory 510, and to generally control operations of the processing system 500 pursuant to the software instructions. The I/O interfaces 504 may be used to receive user input from and/or for providing system output to one or more devices or components.

The network interface 506 may be used to enable the processing system 500 to communicate on a network, such as the Internet 104. The network interface 506 may include, for example, an Ethernet card or adapter or a Wireless Local Area Network (WLAN) card or adapter. The network interface 506 may include address, control, and/or data connections to enable appropriate communications on the network. A data store 508 may be used to store data. The data store 508 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 508 may incorporate electronic, magnetic, optical, and/or other types of storage media. In one example, the data store 508 may be located internal to the processing system 500, such as, for example, an internal hard drive connected to the local interface 512 in the processing system 500. Additionally, in another embodiment, the data store 508 may be located external to the processing system 500 such as, for example, an external hard drive connected to the I/O interfaces 504 (e.g., SCSI or USB connection). In a further embodiment, the data store 508 may be connected to the processing system 500 through a network, such as, for example, a network-attached file server.

The memory 510 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 510 may have a distributed architecture, where various components are situated remotely from one another but can be accessed by the processor 502. The software in memory 510 may include one or more software programs, each of which includes an ordered listing of executable instructions for implementing logical functions. The software in the memory 510 includes a suitable Operating System (O/S) 514 and one or more programs 516. The operating system 514 essentially controls the execution of other computer programs, such as the one or more programs 516, and provides scheduling, input-output control, file and data management, memory management, and communication control and related services. The one or more programs 516 may be configured to implement the various processes, algorithms, methods, techniques, etc. described herein.

### Cloud

The processing system 500 can be used to form a cloud system, such as a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” In an embodiment, the systems and methods described herein can be implemented as a cloud service or SaaS.

### Conclusion

Again, it will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain nonprocessor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, at least one processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A non-transitory computer-readable medium configured to store a program executable by a processing system, the program including instructions configured to cause the processing system to:
obtain time series data from a network;
determine one or more forecasters to use based on a type of the time series data and based on previous training that determine that the one or more forecasters from a plurality of forecasters are best suited for the type of time series data;
make a forecast of the time series data using the one or more forecasters; and
one or more of save and display the forecast.

2. The non-transitory computer-readable medium of claim 1, wherein the time series data has patterns therein and the determining is based on the one or more forecasters best suited for the patters.

3. The non-transitory computer-readable medium of claim 1, wherein the time series data includes any of Signal-to-Noise Ratio, Bit Error Rate, packet losses, and packet counts.

4. The non-transitory computer-readable medium of claim 3, wherein when the time series data is Signal-to-Noise Ratio, using a first model trained for Signal-to-Noise Ratio patterns in the time series data.

5. The non-transitory computer-readable medium of claim 4, wherein when the time series data is a submarine Signal-to-Noise Ratio, using a second model trained for submarine Signal-to-Noise Ratio patterns in the time series data.

6. The non-transitory computer-readable medium of claim 4, wherein when the time series data is a terrestrial Signal-to-Noise Ratio, using a second model trained for terrestrial Signal-to-Noise Ratio patterns in the time series data.

7. The non-transitory computer-readable medium of claim 3, wherein when the time series data is Bit Error Rate, using a first model trained for Bit Error Rate patterns in the time series data.

8. The non-transitory computer-readable medium of claim 3, wherein when the time series data is packet losses, using a first model trained for packet losses patterns in the time series data.

9. The non-transitory computer-readable medium of claim 3, wherein when the time series data is packet count, using a first model trained for packet count patterns in the time series data.

10. The non-transitory computer-readable medium of claim 1, wherein determining further includes selecting a same forecaster with different parameters.

11. The non-transitory computer-readable medium of claim 1, wherein based on feedback from the forecast, reperform the training to determine the one or more forecasters from the plurality of forecasters are best suited for the type of time series data.

12. A system for detecting outliers of network data, the system comprising:
one or more processors; and
a memory in communication with the one or more processors, the memory configured to store instructions for detecting outliers of network data,
wherein the instructions, when executed, cause the one or more processors to obtain time series data from a network;
determine one or more forecasters to use based on a type of the time series data and based on previous training that determine that the one or more forecasters from a plurality of forecasters are best suited for the type of time series data;
make a forecast of the time series data using the one or more forecasters; and
one or more of save and display the forecast.

13. The system of claim 12, wherein the time series data has patterns therein and the determining is based on the one or more forecasters best suited for the patters.

14. The system of claim 12, wherein the time series data includes any of Signal-to-Noise Ratio, Bit Error Rate, packet losses, and packet counts.

15. The system of claim 14, wherein when the time series data is Signal-to-Noise Ratio, using a first model trained for Signal-to-Noise Ratio patterns in the time series data.

16. The system of claim 15, wherein when the time series data is a submarine Signal-to-Noise Ratio, using a second model trained for submarine Signal-to-Noise Ratio patterns in the time series data.

17. The system of claim 14, wherein when the time series data is Bit Error Rate, using a first model trained for Bit Error Rate patterns in the time series data.

18. The system medium of claim 12, wherein determining further includes selecting a same forecaster with different parameters.

19. A method comprising the steps of:
obtaining time series data from a network;
determining one or more forecasters to use based on a type of the time series data and based on previous training that determine that the one or more forecasters from a plurality of forecasters are best suited for the type of time series data;
making a forecast of the time series data using the one or more forecasters; and
one or more of saving and displaying the forecast.
